(19) United States
(12) Patent Application Publication
(10) Pub. No.: US 2025/0390084 A1
(43) Pub. Date: Dec. 25, 2025

(54) SYSTEMS FOR PROOF-EMBEDDED CYBER-PHYSICAL PASSPORTS AND RELATED METHODS

(71) Applicant: BOARD OF REGENTS, THE UNIVERSITY OF TEXAS SYSTEM, Austin, TX (US)

(72) Inventors: Gabiela Ciocarlie, San Antonio, TX (US); Ananth Grama, West Lafayette, IN (US); Dongyan Xu, West Lafayette, IN (US)

(21) Appl. No.: 19/309,439

(22) Filed: Aug. 25, 2025

Related U.S. Application Data
(63) Continuation-in-part of application No. 18/949,196, filed on Nov. 15, 2024.
(60) Provisional application No. 63/599,526, filed on Nov. 15, 2023.

(51) Int. Cl. G05B 19/418

(52) U.S. Cl. CPC G05B 19/4183; G05B 19/41835; G05B 19/4185

(57) ABSTRACT

The present disclosure presents systems and methods for creating and recording digital cyber-physical passports during a manufacturing process. One such system or method is adapted to supply manufacturing data for a particular physical part instance being manufactured by the manufacturing machine; track a progress of the manufactured part instance and store manufacturing data supplied by the one or more monitoring devices and/or the manufacturing machine in a data store; generate digital cyber-physical passports for each completed phase of manufacturing for the particular part instance, wherein the cyber-physical passport contains proof data associated with the physical part instance, wherein the proof data indicates a compliance status of the particular part instance with one or more tolerance requirements, structural requirements, functional requirements, manufacturing requirements, or compatibility requirements; and record individual cyber-physical passports on a cyber-physical passport-linked ledger on a distributed ledger technology platform during the manufacturing process of the part instance.

### CROSS-REFERENCE TO RELATED APPLICATION

This application is a continuation-in-part of co-pending U.S. utility application entitled, “Systems for Cyber-Physical Passports and Related Methods,” having application Ser. No. 18/949,196, filed Nov. 15, 2024, which claims priority to co-pending U.S. provisional application entitled, “Cyber-Physical Passports,” having Ser. No. 63/599,526, filed Nov. 15, 2023, each of which is entirely incorporated herein by reference.

### STATEMENT REGARDING FEDERALLY SPONSORED RESEARCH OR DEVELOPMENT

This invention was made with government support under Award No. DOE DE-EE0009046 awarded by the United States Department of Energy. The government has certain rights in the invention.

### BACKGROUND

While digital automation has optimized the visibility and control of industrial production processes, it has also introduced vulnerabilities. Digital systems are susceptible to theft, manipulation, and disruption. The critical step in securing an industry's workflows and supply chains is an improved ability to monitor operations and establish trustworthy and attested signals of baseline operation and quality of the produced product. Absent that capability, the manufacturing workflows that underpin the industry's economy will remain vulnerable to attack, disruption, and manipulation and impossible to trust the manufacturing workflow and/or the produced product.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a block diagram of an example environment suitable for practicing systems and methods of the present disclosure;

FIG. 2 shows components of an exemplary cyber-physical passport application in accordance with various embodiments of the present disclosure.

FIGS. 3-6 show images of exemplary graphical user frontend interfaces to an exemplary dashboard application in accordance with various embodiments of the present disclosure.

FIG. 7 is a block diagram illustrating an exemplary computing system or device that can be utilized for systems and methods of the present disclosure.

FIG. 8 is a flow chart illustrating an exemplary method that may be implemented by the computing system of FIG. 7.

### DETAILED DESCRIPTION

The present disclosure relates to systems and methods for embedding proof-carrying information in digital cyber-physical passports of manufacturing data and processes in a linked structure that can be queried using a network or application interface to provide different data items (e.g., time-series data, supply chain details, etc.) for each operation/step performed in a manufacturing process for physical part(s).

Consider that in conventional cyber-physical monitoring systems, large amounts of data from different sources are collected. The volume and lack of structure in this data quickly overwhelms analyses and query infrastructure. In accordance with the present disclosure, one important problem cyber-physical passports solve is to provide structure to this data by organizing and linking data associated with different parts, processes, and artifacts. A second problem associated with data is the potential for data corruption. However, in accordance with various embodiments, cyber-physical passports store data in immutable objects, thus ensuring integrity of data. A third problem is associated with attribution—who stored the data and when. In accordance with various embodiments of the present disclosure, cyber-physical passports store this information through cryptographically signed objects. Finally, data stored at different manufacturing sites may not be shared outside of the facility. As such, in accordance with various embodiments, cyber-physical passports allow for controlled access to data through distributed ledgers. Taken together, cyber-physical passports provide complete and secure provenance for all data objects associated with various manufacturing processes, parts, and artifacts, in flexible and linked data structures that can be quickly queried and used for a wide variety of analyses.

As a non-limiting example, a manufacturing infrastructure can be configured to create, index, and store immutable records of all manufacturing data and processes in a semantically rich linked set of digital cyber-physical passports or records, where each passport may be stored in a distributed ledger technology (DLT) network and indexed through a universal unique identifier (UUID), while manufacturing data objects related to each passport may be stored in a local data server for a manufacturing facility site or plant and/or may be stored in a cloud or remote network site that is accessible to the manufacturing site. Therefore, the resulting linked structure of cyber-physical passports can be queried using the passport UUID for various manufacturing data objects, processes, and artifacts that are referenced or linked in the passport, such as computer-aided designs (CAD), reports on operators, machine(s), and/or part instance details, etc. Accordingly, in various embodiments, a link between a passport UUID and a physical part can be established using a watermark that is embedded or secured to the physical part (e.g., quick-response (QR) code)) engraved or etched in a physical part) and is encoded with the UUID (or other type of identifier). As mentioned, the linked passport structure can be queried using a network or application interface (e.g., by using a programmatic interface (e.g., through Python) or a visual point-and-click interface), where different data items (e.g., time-series data for tool-tip, stresses, energy consumption) can be retrieved.

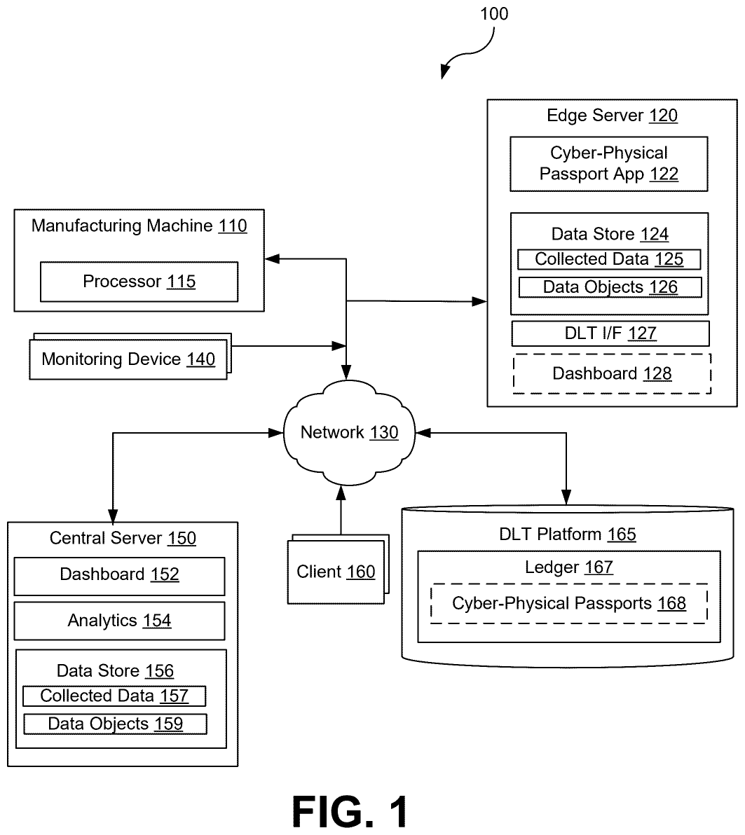

FIG. 1 shows a block diagram of an example environment 100 suitable for practicing the systems and methods described herein. It should be noted, however, that the environment 100 is just one example and is a simplified embodiment provided for illustrative purposes, and reasonable deviations of this embodiment are possible as will be evident to those skilled in the art. As shown in FIG. 1, the environment 100 may include at least one manufacturing machine (e.g., 3D printer, a computer numerical control (CNC) machine, etc.) 110 having a processor 115 that is configured to fabricate or be involved in fabrication of a part within a manufacturing process at a manufacturing facility or plant. The environment further includes an edge server 120 that is coupled to the manufacturing machine 110 over a communication network 130 within the manufacturing facility. The edge server 120 may be configured to monitor and perform operations within the manufacturing facility, such as communicating instructions (input data) to the manufacturing machine 110 and receiving output, such as status information, on the manufacturing process from the machine 110. Correspondingly, the edger server 120 may be configured to receive environmental and manufacturing sensor data from one or more manufacturing monitoring devices 140 and machine(s) 110 coupled directly to the edge server 120 or in communication with the server over the network 130.

In various embodiments, the environment 100 may further include a central server 150 that is located remotely from the edge server 120. In some other embodiments, the central server 150 may be implemented as a cloud-based computing resource shared by multiple users. The cloud-based computing resource(s) can include hardware and software available at a remote location and accessible over a network (for example, the Internet). The cloud-based computing resource(s) can be dynamically re-allocated based on demand. The cloud-based computing resources may include one or more server farms/clusters including a collection of computer servers which can be co-located with network switches and/or routers.

In this way, the edge server 120 can transmit collected sensor data and manufacturing status information 125 to the central server 150, where the central server 150 can aggregate data from the manufacturing facility and possibly other manufacturing facilities at other locations and perform analyses on the data and/or make the data available for viewing and searching by remote client computing devices 160, such as from a digital dashboard application 128. In various embodiments, the digital dashboard application 52 may be hosted on the edge server 120 and/or the central server 150 and/or may be distributed between multiple servers 120, 150, such that certain functions may be accessible using the edge server 120 (and its data store(s) 124) and other functions may be accessible using the central server 150 (and its data store(s) 156). In various embodiments, the client computing devices 160 include, but is not limited to, a laptop computer, a tablet computer, a desktop computer, a mobile phone, and so forth. The client computing devices 160 can include any appropriate device having network functionalities allowing the client(s) 160 to communicate to server(s) 120, 150. In some embodiments, the client(s) 160 can be connected to the server(s) 120, 150 via one or more wired or wireless communications networks.

In turn, the edge server 120 may be configured to generate digital cyber-physical passports (via a cyber-physical passport component application 122) to allow for documenting each step or operation performed in manufacturing of a physical part and subsequent tracking of operations and associated processes involved in manufacturing of a physical part, even across multiple suppliers or vendors. The individual cyber-physical passports may be linked to data objects 126 prepared and/or stored by the edge server 120, such as sensor data, manufacturing or status reports, etc. Accordingly, in various embodiments, the edge server 120 may be configured to automatically connect to one or more manufacturing monitoring devices 140 (e.g., within a manufacturing facility that is remote from the server 120) that measure environmental or physiological parameters of the manufacturing machine 110 or facility, such as through short range communication (e.g., involving one or more Bluetooth protocols). The edge server 120 may be configured to receive incoming data packets from the manufacturing monitoring device(s) 140 and may perform functions to analyze the incoming data locally. The edge server 120 may also send data packets back to the manufacturing monitoring devices 140 in order to perform functions such as setting the time or other settings on the monitoring devices 140.

In various embodiments, the monitoring devices 140 may be configured to send sensor data (or other type of manufacturing data) through far field communications, such as cellular communications (e.g. via a variety of protocols such as LTE-M and NB-IoT) or WiFi communications, to the edge server 120. In various embodiments, communications between the manufacturing monitoring devices 140 and edge server 120 can be routed through an MQTT broker, MT connect broker, etc. that serves as an intermediate entity between the manufacturing monitoring devices 140 and edge server 120. The edge server 120 can then send or relay data to the central server 150.

Various types of manufacturing monitoring devices 140 can be employed in the environment 100, such as machine sensors for energy consumption measurement, measuring physical parameters, such as tool placement and vibration, and environment sensors that measure temperature, geometry, spindle speed, among others.

With the data collected from the manufacturing monitoring devices 140 and/or manufacturing machines 110, the edge server 120 may be configured to prepare various types of cyber-physical passports documenting the operations being performed. Accordingly, in various embodiments, the edge server 120 is configured to interface with a distributed ledger technology (DLT) network or platform 165. In various embodiments, the distributed ledger platform 165 represents synchronized, eventually consistent, data stores or databases spread across multiple nodes in different geographic or network locations. Each node in the distributed ledger platform 165 can contain a replicated copy of a ledger 167 of linked cyber-physical passports 168, including all data stored in the ledger 167. Records of transactions involving the ledger 167 can be shared or replicated using a peer-to-peer network connecting the individual nodes that form the distributed ledger technology (DLT) platform 165. Once a transaction or record is recorded in the distributed ledger 167, it can be replicated across the peer-to-peer network until the record is eventually recorded with all nodes. Various consensus methods can be used to ensure that data is written reliably to the ledger 167 of linked cyber-physical passports 168. In some implementations, data, once written to the ledger 167, is immutable. Examples of a distributed data store that can be used for the DLT platform 165 can include various types of blockchains, distributed hash tables (DHTs), and similar data structures. In accordance with embodiments of the present disclosure, cyber-physical passport data can be stored in the ledger 167 associated with respective physical parts that have been fabricated during a manufacturing process.

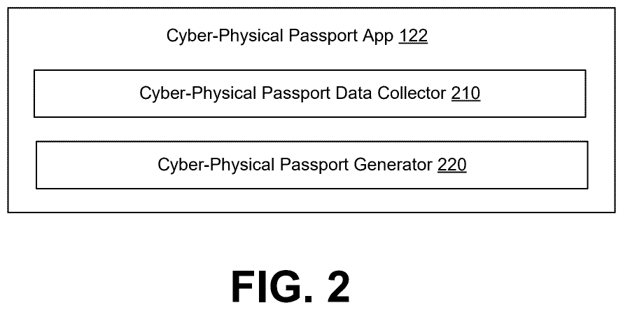

Referring now to FIG. 2 and in accordance with various embodiments, the edge server 120 can comprise a software and/or hardware cyber-physical passport application that has a plurality of components that enable the creation and storage of cyber-physical passports 168 within a DLT network 165. Accordingly, in various embodiments, the cyber-physical passport application 122 includes at least a cyber-physical passport data collector component 210 and a cyber-physical passport generator component 220.

In various embodiments, the cyber-physical passport data collector component 210 is designed to collect relevant manufacturing data on a physical part or item being manufactured during a manufacturing process and prepare the data for storage in a manufacturing data store 124 (FIG. 1) as one or more data objects 126 associated with a physical part/item. Additionally, the cyber-physical passport generator component 220 acts to create cyber-physical passport records 168 that document the various operations being performed during a life cycle of a fabricated part from its conception (design) to its completed manufactured part/item, which may be as a piece in a larger fabricated system.

Accordingly, the cyber-physical passport data collector component 210 may generate or be provided an identifier (e.g., serial number, part name, part number, etc.) associated with the physical part being processed. In turn, during the manufacturing process, a part may be transformed into a new part whereby the new part will also be assigned a new identifier, such that the cyber-physical passport data collector component 210 will store the part identifiers as they are created, whether they are created by the cyber-physical passport data collector component 210 and relayed to other machines/systems on the network 130 of the manufacturing facility and/or are created by other machines/systems and relayed to the cyber-physical passport data collector component 210.

For example, a manufacturing process from start to finish may involve the creation and development of individual parts/items before a final fabricated item is produced. In various embodiments, this life cycle may include a product design phase, a machine phase, a product phase, a transport phase, and/or a product item phase. In turn, an exemplary cyber-physical passport application 122 may collect manufacturing data and generate cyber-physical passports for one or more of these life cycle phases.

To illustrate, a product may undergo a product design phase that produces a software design for an item with the software design file or object (e.g., CAD design file) for the product being assigned its own part identifier (that is subsequently recorded in a cyber-physical passport associated with the product design phase (e.g., a product design passport)). Then, as part of a product phase, the software design file may be converted to machine code (e.g., G-Code file) that is understood by a manufacturing machine 110 (e.g., 3D printer, a CNC machine) and can enable/instruct the machine 110 to fabricate a physical part. Accordingly, the machine code design file may be assigned its part identifier that is stored by the data collector component 210 (and is subsequently recorded in a cyber-physical passport associated with the product phase (e.g., a product passport)). Likewise, during the machine phase, a manufacturing machine 110 (having its own identifier (e.g., machine serial number)) is assigned to produce an instance of the product design (and is subsequently recorded in a cyber-physical passport associated with the machine phase (e.g., machine passport)). After the machine 110 fabricates the physical part, as part of the product item phase, the physical part may be associated with a new part identifier (and is subsequently recorded in a cyber-physical passport associated with the product item phase (e.g., product item passport)). In various embodiments, the physical part may also be physically embedded with a passport UUID on its part as a physical watermark (or other type of signifier), where the cyber-physical passport associated with the product item phase (e.g., product item passport) includes the new part identifier, such that if the physical part is shipped, as part of a transport phase, to a different supplier facility, for further fabrication operations, a new part identifier will be created for the fabricated part at the supplier site, and so on.

Correspondingly, the cyber-physical passport data collector component 210 may collect manufacturing data related to the phases of operation being performed and may associate the collected manufacturing data with the relevant UUID code of the cyber-physical passport associated with a particular phase of operation. Correspondingly, each of the collected sets of data may also be associated with their own data identifiers to differentiate them from one another and from similar types of data collected at different times/locations/instances. Likewise, manufacturing operations that are not associated with the creation of a new part (whether digital or physical) may also be assigned their own identifiers, such as the act of transporting a physical part from a first supplier facility to a second supplier facility. In this instance, a data record documenting the transfer/transport of the part may be associated or assigned its own identifier, where the report may include the identifiers of the part being transported along with the names of the source facility and the target/destination facility, product details, etc. In turn, a cyber-physical passport (having its own UUID) can record the relevant identifiers for digital or data objects stored by edge servers and/or network links for digitally accessing such digital objects. Accordingly, the cyber-physical passport data collector component 210 can request the names of product parts and related details (e.g., product version and project details, facility names, or other identifications, etc.) that are in current fabrication from the relevant data-hubs (e.g., edge servers) within the network 130. Thus, in various embodiments, data associated with various processes or artifacts are stored in digital objects and these objects are associated with passport UUIDs, which can be used to access them.

Correspondingly, a cyber-physical passport generator component 220 is configured to interact with the DLT network 165 and generate and publish digital cyber-physical passports 168 documenting the manufacturing operations and the associated data objects that are created and collected by the cyber-physical passport data collector component 210. Thus, in order to document these varying stages of manufacturing development, different types of cyber-physical passports 168 may be prepared and may be linked to different data objects 126 stored in local data stores 124 of the edge server 120. The different types of cyber-physical passports may correspond to the different phases of product development, such as but not limited to, a product design passport, a machine passport, a product passport, a transport passport, a product-item passport, etc.

As such, the edger server 120 includes a DLT interface 127 (FIG. 1) that facilitates communication with the DLT network 165 and accepts requests from the cyber-physical passport generator component 220 to store passport records on and retrieve record information from the DLT network 165. Storing the described passport transactions to the DLT network 165 can take multiple forms depending on the consensus mechanism used within any particular ledger. These passport transactions form a payload that can be managed by smart contracts, which generate and manage native DLT transactions in a variety of embodiments.

Thus, in various embodiments, each passport type may have the same general scheme of recording passport UUIDs, data object identifiers and/or links (e.g., uniform resource locator (URL)), and a digital signature of the creator of the passport (e.g., a particular edge server 120 or cyber-physical passport application 122) associated with a particular phase, while also being distinguishable by the passport UUIDs, the types of cyber-physical passports associated therewith, and data objects that are being recorded for a particular manufacturing operation being performed. For example, a manufacturing process may begin with a digital design for a product part. Accordingly, a product design passport may be prepared by the cyber-physical passport generator component 220 that includes an identifier for the digital design, an identifier for the digital designer (e.g., employee number, username, etc.), an identifier for a report or document having design details (e.g., version information, design name, an identifier associated with the designer software used to create the design (e.g., Fusion 360), an identifier for the edge server 120 or component 220 that is creating the passport, etc. In turn, the cyber-physical passport generator component 220 may create a digital “product design” passport file with a new UUID and having the individual identifiers (keys) recorded in the file along with a digital signature that is created by computing a hash for the passport record and encrypting it with a private key of the cyber-physical passport generator component 220. Further, the digital design may be broken into individual digital designs for component parts of an overall “composite” product part (that is formed of multiple component parts). Accordingly, each component part may be associated with an individual product design passport that references the product design passport (e.g., UUID for the product design passport) of each component parts.

Later, when machine-code instructions (e.g., G-code file) are prepared from the digital design for the product part, a “product” passport may be prepared by the cyber-physical passport generator component 220 that includes the UUID for the product design passport or other passports associated with operations previously performed in the manufacturing process. In cases, where a digital design for a product part is broken into individual digital designs for component parts of the overall “composite” product part (that is formed of multiple component parts), each component part may be associated with an individual product passport that references the product passport (e.g., UUID for the product passport) for each component part.

In various embodiments, the product passport may also include an identifier and/or link for a G-code design file, an identifier and/or link for the digital design file from which the G-code file was created from, an identifier and/or link for a report or document having design details (e.g., version information, design name, an identifier associated with the G-code software used to create the machine-code file, an identifier for the edge server 120 or component 220 that is creating the passport, etc.). Further, the cyber-physical passport generator component 220 adds a digital signature to the cyber-physical passport that is created by computing a hash for the product passport record and encrypting it with a private key of the cyber-physical passport generator component 220.

Then, when one or more machines 110 are configured to execute the G-code (or other type of machine-code file) to fabricate a physical part, a “machine passport” may be prepared with manufacturing details for the machine 110. Accordingly, the machine passport may be prepared by the cyber-physical passport generator component 220 that includes the UUID for the product passport or other passports associated with operations previously performed in the manufacturing process. In various embodiments, the machine passport may also include an identifier for the machine 110, an identifier for a report or document having machine details, parameters, or specifications, an identifier for a report or document having location details for the machine 110, an identifier for the edge server 120 or component 220 that is creating the passport, etc. along with a digital signature that is created by computing a hash for the passport record and encrypting it with a private key of the cyber-physical passport generator component 220.

In cases, where a digital design for a product part is broken into individual digital designs for component parts of the overall “composite” product part (that is formed of multiple component parts), each component part may be associated with an individual machine passport that references the machine passport (e.g., UUID for the machine passport) for each component part of the overall or composite product part.

Correspondingly, after collecting data from manufacturing monitoring devices 140 during manufacturing, the collected sensor and/or manufacturing data can be identified by a “product item” passport which is linked to the product passport and/or machine passport, in various embodiments. Thus, each additional step in the manufacturing process may be enabled to create additional digital cyber-physical passports such that each passport is a permanent, immutable record of the production of a physical part. In various embodiments, a front end graphical user interface of the dashboard application 128 of the edge server may be accessed to select types of data to be collected by the edge server 120 from available manufacturing monitoring devices 140 and/or machines 110.

In cases, where a digital design for a product part is broken into individual digital designs for component parts of the overall “composite” product part (that is formed of multiple component parts), each component part may be associated with an individual product item passport that references the product item passport (e.g., UUID for the machine passport) for each component part instance of the overall or composite product part instance.

In various embodiments, in addition to the collected sensor and/or manufacturing data, an exemplary product item passport can include proof data indicative of satisfying (or not satisfying) certain compliance requirements (e.g., computed values within defined acceptable ranges), such as, but not limited to, regulatory requirements, safety standards, environmental regulations, quality control assurances, structural or functional specifications, industry-specific certifications, etc. Further, proof of compliance with various part tolerances (whether dimensional tolerances, geometric tolerances, fit tolerances, etc.) may be specified in product items passports to ensure proper function and/or assembly of the part instance in an overall system. For example, a linear tolerance may specify an allowable variation in a part's length, width, height, or diameter, where a part instance may be checked to meet the allowed variance range for the part, such that a product item passport for the part instance may record the part instance's measured dimensional value to show that it is within an allowed range of the linear tolerance requirement or may contain a logical value (e.g., True) indicating that the part instance has been verified to be in the allowed range of the linear tolerance requirement.

Additionally, or as an alternative thereto, in various embodiments, an exemplary product item passport can include proofs of satisfying (or not satisfying) certain functional specification requirements, which can encompass how a part should behave, including performance, reliability, and safety and can be used to show if a part is performing its intended function correctly and/or reliably. Example types of functional specification requirements can include an accuracy requirement, speed requirement, efficiency requirement, failure requirement, reliability requirement, interfacing requirement (with other components in an overall system), compatibility requirement (with other components in the overall system), industry standard requirement, temperature requirement, humidity requirement, vibration requirement, material requirement, etc.

A proof associated with a part may also contain mathematical, logical, or other types of formulae. These formulae correspond to proofs associated with the passport and underlying object. The formulae may have variables that draw values from the part associated with the passport, parts that are used to construct the part associated with the passport, or proofs that the subparts satisfy specific properties. As an example, if a part is composed of two subparts and each of the subparts satisfy specific properties (e.g., their dimensions are within acceptable tolerances) and the parent part itself satisfies required properties (i.e., in addition to the subparts satisfying specifications and the part assembly itself satisfies requirements), then the proof for the part itself is asserted to be true. Mathematical formulae may similarly correspond to physical properties of parts that can be derived from properties of sub-parts.

If the fabricated part is transported to a second facility for additional manufacturing processing, the cyber-physical passport generator component 220 may prepare a “transport” passport documenting details of the transfer. Accordingly, the transport passport may be prepared by the cyber-physical passport generator component 220 that includes the UUID for the product-item passport or other passports associated with operations previously performed in the manufacturing process. In various embodiments, the transport passport may further include an identifier for the fabricated part being transported, an identifier for the facility site from where the part is being shipped, an identifier for the facility site to where the part is being shipped, an identifier for and/or link for accessing a report or document having facility location and timing details for the source, an identifier for and/or a link for accessing a report or document having facility location and timing details for the destination, an identifier for the edge server 120 or component 220 that is creating the passport, etc. along with a digital signature that is created by computing a hash for the passport record and encrypting it with a private key of the cyber-physical passport generator component 220.

Accordingly, each of the prepared digital cyber-physical passports can be published on the DLT network 165 by the cyber-physical passport generator component 220 during the lifecycle of the fabricated part or item. Since each passport record includes or links to an identifier for the edge server 120 that prepared the passport, identifiers and/or links for accessing data objects 126 referenced in the passport records may be accessible through the edge server 120 (if the requesting user has proper authorization) via network or application interfaces, such as standard web browsers and/or programming interfaces over network 130. These data objects 126 can include sensor data reports, manufacturing data reports, associated reports, tracking data, compliance requirement status reports, compliance tolerance reports, functional specification requirement status reports, etc. that have been collected by the cyber-physical passport data collector component 210 and stored in the manufacturing data store 124. Likewise, in various embodiments, identifiers and/or links for data objects referenced in the passport records may be accessible through the central server 150 (if the requesting user has proper authorization) via network or application interfaces, such as standard web browsers and/or programming interfaces over network 130. These data objects can include sensor data reports, manufacturing data reports, associated reports, tracking data, compliance requirement status reports, compliance tolerance reports, functional specification requirement status reports, etc. that have been collected and forwarded to the central server 150 by one or more edge servers across various manufacturing facilities.

Accordingly, in certain embodiments, the central server 150 may store collected data 157 and/or data objects 159 (in a data store 156) obtained from various manufacturing facilities which provides it the capability to perform various data analyses on the collected data that can be accessed from a dashboard application 128.

If we assume, in accordance with the present disclosure, that each unique part instance constructed from the same G-code will have its own distinct sensor data, compliance requirement data, tolerance requirement data, functional specification data, etc. and will be linked to the same product passport (that contains the part identifier for the same G-code as payload), analytics software 154 (FIG. 1) on the central server 150 can examine the collected data for the different part instances that share the same product passports selected using a frontend interface for the dashboard application 128.

Since each product item passport is identified by a universal unique identifier or UUID, a user can select, using the front end interface to the dashboard application 128, a UUID obtained from a product passport and a type of manufacturing data (e.g., temperature sensor data, energy consumption data, geometry data, spindle speed data, etc.) and/or a type of status data (e.g., compliance requirement status reports, compliance tolerance status reports, functional specification requirement status reports, etc.) to be examined in order to cause the dashboard application 128 to generate a visualization chart or graph (e.g., time-series chart) of the selected type of manufacturing data (e.g., energy consumption data). In various embodiments, this type of operation can be performed for multiple passports 168 to examine differences between them, such as data for multiple passports 168 can be incorporated into and visualized on a common graph. Thus, in various embodiments, the analytics software 154 (e.g., Jupyter analytics platform), used to support the dashboard application 128 can be programmed to select one of more cyber-physical passports 168, select a manufacturing data object or type of sensor data, perform a data analytics function, and display results of the performed analyses.

Thus, in various embodiments, digital cyber-physical passports 168 can record how a physical part was designed and made which constitutes a durable provenance track that can be used in future audits, optimization of energy, and security properties. For example, the edge server 120 and/or central server 150, via the dashboard application 128 and related analytics software 154, are configured to present visual reports, such as a visualization tree, of the provenance lifecycle of a product part instance, time-series data for the product-part instance, comparative time-series data for multiple product part instances, etc., using information made available via the stored digital cyber-physical passports 168. Thus in accordance with various embodiments of the dashboard application 128 and analytics software 154, manufacturing conditions for one product instance can be compared against those in the future to ensure the continued integrity of a manufacturing process. As such, examination of these types of conditions are useful for examining part defects/failures to learn what manufacturing conditions might be correlated with a potential problem.

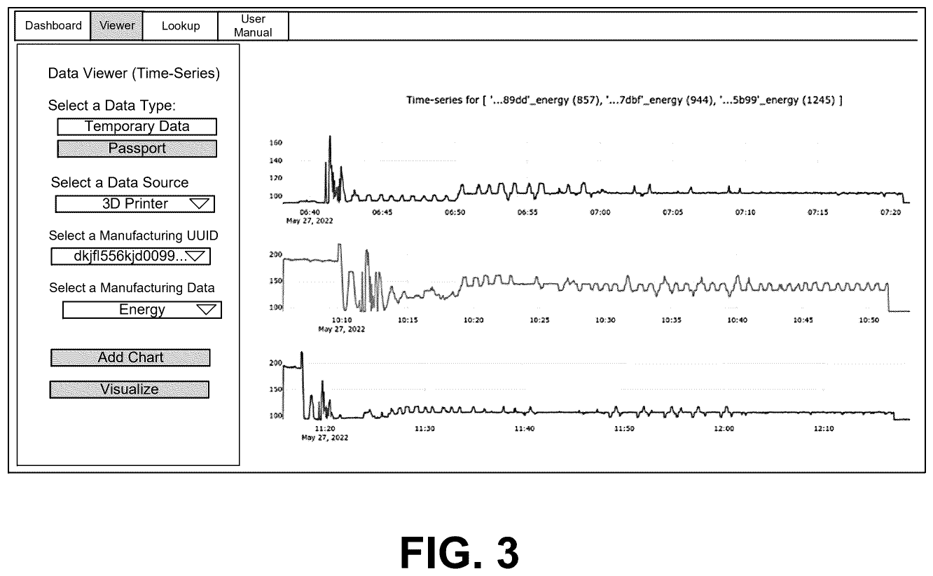

Referring now to FIGS. 3-6, the figures show screenshots or images of exemplary graphical user frontend interfaces to the dashboard application 128 hosted by the server(s) 120, 150 and made available to client computing devices 160. In FIG. 3, three data objects from three different passports (corresponding to three instances of the same product) are selected in the frontend interface to the dashboard application 128 and are converted to a visualization chart showing that the three data sets from the three different passports (corresponding to three instances of the same product/part) differ from one another and is indicative of a defective part instance produced when a manufacturing machine 110 (e.g., 3D printer) was experiencing an anomaly (e.g., network or hardware attack or fault).

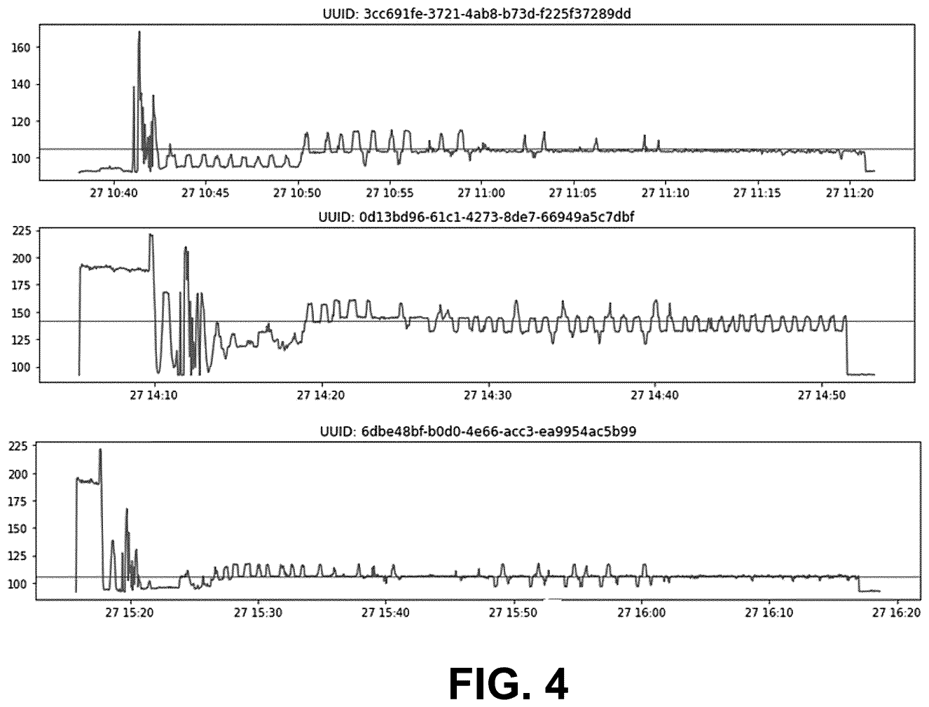

In FIG. 4, a data analytics function is selected from the dashboard application 128 that causes the graphical user interface to the dashboard application 128 to display these results showing a horizontal line in each plot indicating the bounded average of energy consumption over time for printing each of the three part instances. From this display, it can be determined that the graph in the middle exhibits an anomaly. While this example is provided for illustration purposes, such data analytics operations can be extended to more sophisticated algorithms to be applied to an ensemble of part passport data, in various embodiments.

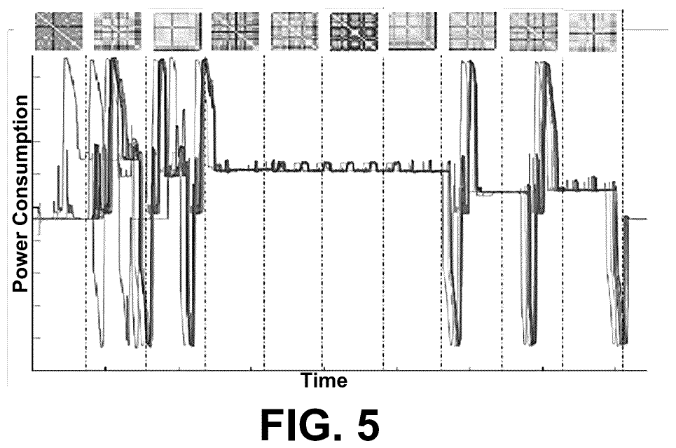

As a more complex data analytics example, temporal energy consumption pattern has been found to be an effective indicator of manufacturing anomaly. As shown in FIG. 5, energy use parameters can be collected by their respective edge server 120, and then segmented for each part by the analytics software 154. By overlaying each energy use pattern, windowed correlation analysis on each time segment of the data collection can be performed, in various embodiments, to identify an anomaly and normal behavior relative to other parts. This is the kind of analytics that is enabled by the analytics software 154 in the central server 150, in various embodiments.

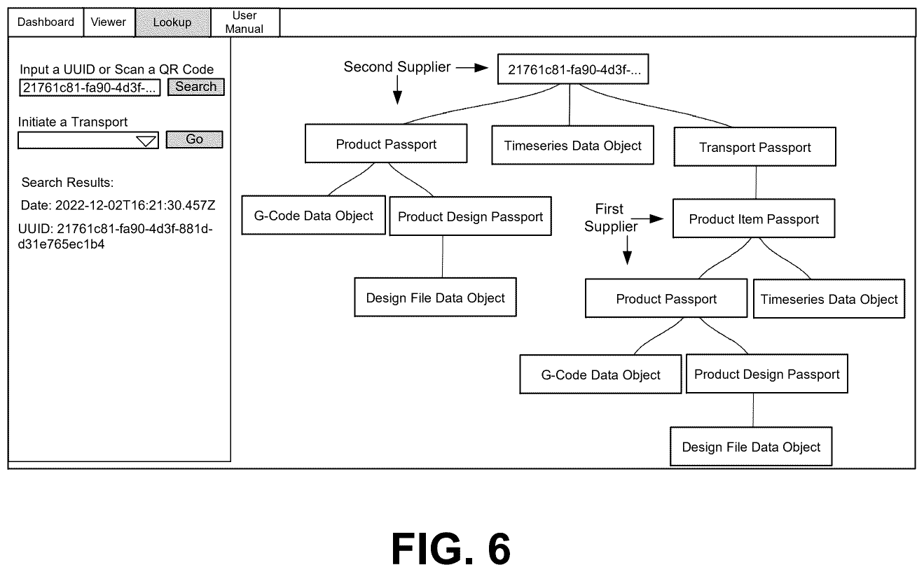

Also, by using the dashboard application 128 and the various cyber-physical passports 168 for a finished product part, a visual representation of a complete provenance trail of the product can be created, as illustrate in FIG. 6. In this example, the manufacturing process for the final product involves a first supplier creating a first version of the product that is transported to a second supplier which updates or modifies the first version of the product to create a final version of the product, where a plurality of cyber-physical passports 168 are created and published on DLT ledger 167 during each operation of the manufacturing process. Accordingly, since each entry in the distributed technology ledger 167 refers back to a part and its supplier, the linked set of digital cyber-physical passports 168 can be used to recursively construct a product provenance trail across multiple manufacturing facilities (and their respective edge servers and data stores). Note that, in various embodiments, while suppliers (manufacturing facilities) may choose to limit visibility of information to external queries, a record of the source part and its provider still exists in a transport cyber-physical passport of the second supplier's data-hub (edge server and data store(s)).

For the example depicted in FIG. 6, the first supplier fabricates an unfinished part and ships it to the second supplier for required finishing. The second supplier receives the part and scans it to create a record in its own data-hub (e.g., data server/data store). In various embodiments, that record is a data object 126 (having an identifier and/or data link) that is referenced in a transport passport (using the identifier/link of the data object) and is published in the DLT network or platform 165, where the transport passport describes the original first supplier and a product item passport UUID designated by the first supplier. The second supplier may then use its own design information for a CNC machine to etch a logo onto the 3D printed part. As it does so, sensor data (or other type of manufacturing data) are collected by an edge server 120 at the second supplier's manufacturing facility. The final product item includes the etched design, such that a product item passport for the final product item may include the UUID for the transport passport or other passports associated with operations previously performed in the manufacturing process. In various embodiments, the product item passport may further include at least a part identifier for the final product item, an identifier or link for a report on the sensor data collected by the edge server 120, and the part identifier for the original transported part from the first supplier. In this illustrative example, an identifier for the product item passport may also be affixed to the final product item (e.g., such as in the form of a physical watermark (e.g., an embedded QR code)). As shown in the left panel of the dashboard interface illustrated in FIG. 6, the finished physical watermark can be input into an exemplary dashboard interface and be used as root of a passport hierarchy in a visualization tree of the provenance lifecycle of the final product. To do so, the passport UUID represented by the physical watermark may be queried by smart contracts (via inputs from DLT interface) to populate and construct the branches and nodes of the visualization tree in order to refer to all of the previous manufacturing steps involved in fabrication of the final product part.

Processes and entities in cyber-physical systems often generate or obtain information showing that a manufactured part or related process satisfies or complies with internal or extrinsic requirements or tolerances for the particular physical part. For instance, a manufactured part instance (product item) may receive certifications (e.g., that the manufactured product item meets certain tolerance, functional, or structural requirements set for the product part), compliance standards (e.g., a part complies with certain manufacturing requirements), and/or compatibility requirements (e.g., a part is compatible for use in specific contexts). Embedding this status information into relevant cyber-physical passports 168 corresponding to the physical part instance or related process has significant benefits. First, since cyber-physical passports 168 are authenticated and immutable in the distributed ledger 167, this information (e.g., compliance) is trusted. Second, since physical parts are often assembled into other complex parts, the information from such component parts can be used to establish the status information relating to the complex part (e.g., compliance status of each component part can be composed to establish the compliance status of the overall composite part). Third, if the status information corresponding to the physical part instance is subsequently found to be incorrect, the linkages amongst the chain of cyber-physical passports 169 carrying the proof or evidence (e.g., computed value of relevant formula that is within a defined acceptable range) corresponding to the physical part can be used to propagate corrected or updated status information update to identify the affected parts in the supply chain. Finally, such information can be used for root-cause analysis to identify the causal factors associated with observed artifacts in supply chains.

Regarding such proof-carrying cyber-physical passports, in various embodiments, a tolerance or functional/structural specification may be stored as a formula (e.g., mathematical formula, logical formula, etc.) in a passport for the general physical part or product, such as a product design passport or a product passport, where an instance of the part (or product item) provides values to each of the variables in the formula and evaluates the formula to establish proof of the tolerance or functional/structural requirement, where a formula value or “proof” that the product item complies with the formula requirement is included or carried by a passport corresponding to the product instance, such as a product item passport. For example, consider the case of a manufactured composite part with several components. In this case, the formula for specification of the composite part can contain variable values that are provided by the component parts and are carried by the product item passports for the component parts. In this case, to compute the formula proof for the composite part instance, the values for instances of the components are obtained from the product item passports for the component part instances in order to evaluate the formula for the composite part instance. Note that the formula for the composite part may include other parameters for the part in addition to its components. After determining or computing the formula value, this value can be included in the product item passport for the composite part, as proof of compliance (or non-compliance) with the particular tolerance or functional/structural requirement represented by the formula (e.g., carried in the product passport for the composite part).

The formula carried by the passport for the general physical part or product, such as a product design passport or a product passport, may have variables that are supplied by passports of the physical part other than the passport for the part instance. For example, a product passport may specify that a material quality (e.g., a flammability rating for a product material) for the product that does not change for any of the individual product items or part instances, since all parts will be manufactured using the same material. Accordingly, all instances of this generic part may inherit certain values from the generic part. In this case, to compute the formula proof for the part instance, certain values in the formula proof are obtained from the product passport, product design passport, machine passport, or other passport besides the product item passport in order to evaluate the formula proof for the part instance.

In one embodiment, a formula proof that is carried in a cyber-physical passport for a product or physical part comprises a logic formula corresponding to a compliance requirement. In various embodiments, the logic formula involves various process parameters for fabrication of a composite part, such as compliance variables of component parts, and logic variables associated with manufacturing machine(s) 110, and other variables as needed, where the logic formula may be expressed in various logic standards, such as first order (predicate) logic.

As a non-limiting example, an instance of a composite part (e.g., part C) uses specific instances of component parts (e.g., part A and part B) in fabrication. In this example case, all logic formula variables associated with parts A and B, the fabrication process variables for part C, and other variables are all instantiated (i.e., they have values). As such, the instantiated values can be substituted in the logic formula stored at the general passport (e.g., product item passport) for part C and the resulting value (e.g., True or False) is stored in the corresponding passport (e.g., product item passport) for the composite part instance, where the resulting value may be considered to be “proof” of whether the instance of part C satisfies the compliance requirements or not (represented by the logic formula).

If in the future, the compliance status of a physical part (e.g., part A) is changed (e.g., from True to False), a new passport (e.g., product item passport) that carries the compliance status value (e.g., proof) can be created, since the prior passport record is immutable. Accordingly, the new passport that is created can also store data relating to the change in compliance status (e.g., time of change of status, agent who changed status, etc.) and can be linked to the chain of passports 169 corresponding to the physical part, such as part A in the non-limiting example discussed above. Accordingly, the change in compliance status of the physical part A can then be propagated (in this case, to part C) using the passport chain and the formula proof for part C is re-evaluated. If this re-evaluation results in a change of compliance status of part C, then a new version of the passport for part C (e.g., product item passport) that carries the compliance status value (e.g., proof) can be created, and the status change can be propagated to linked passports for part C. Also, in this example, if a part is observed to have specific functional or structural properties (e.g., a part that fails more than expected), the properties can be correlated with the compliance status of all the components and process variables associated with the part and all of its constituent parts.

Proof of compliance with various part tolerances (whether dimensional tolerances, geometric tolerances, fit tolerances, etc.) may also be specified in passports (e.g., product item passports) to ensure proper function and/or assembly of the part instance in an overall system. Consider a composite part C that is comprised of component parts A and B. In this case, the product item passport of part C may contain a mathematical formula that relates all process and structural parameters for part C, along with parameters of parts A and B to establish whether part C satisfies tolerance requirements, where the parameters are stated as variables in the mathematical formula. As before, when the generic parts A and B are specialized into instances, the instantiated parameters of parts A and B are applied in the proof formula carried in the product item passport for composite part C to establish a tolerance value for the specific instance of part C.

In another example, a proof of functional specification may also be specified in passports (e.g., product item passports) to establish whether a product item or part satisfies a certain functional specification requirement. Let's again consider a composite part C that is comprised of component parts A and B. In this case, the product item passport of part C may contain a mathematical formula that relates process, structural, and/or functional parameters for parts A and B to establish whether part C satisfies functional specification requirement(s), where the parameters are stated as variables in the mathematical formula. As before, when the generic parts A and B are specialized into instances, the instantiated parameters of parts A and B are applied in the proof formula carried in the product item passport for composite part C to establish a functional value for the specific instance of part C, which can be used to show that an instance of part C satisfies a functional specification requirement, such as meeting specific accuracy and precision standards.

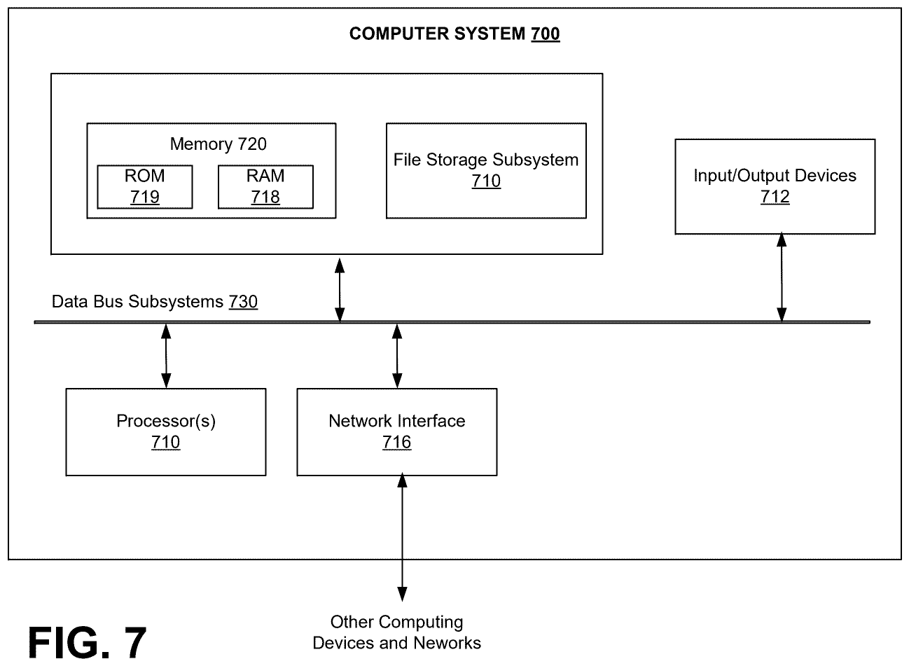

Next, FIG. 7 is a block diagram illustrating an exemplary computing system or device 700 (e.g., server 120, server 150) that can be utilized for systems and methods of the present disclosure. Computing system 700 includes at least one processor, e.g., a central processing unit (CPU), 710 coupled to memory elements 720 through a data bus 730 or other suitable circuitry. Computing system 700 stores program code within memory elements 720. Processor 710 executes the program code accessed from memory elements 720 via the data bus 730. In one aspect, computing system 700 may be implemented as a computer or other data processing system or server computers that are accessed using browsers at client computers 160. It should be appreciated, however, that computing system 700 can be implemented in the form of any system including a processor and memory that is capable of performing the functions described within this disclosure.

Memory elements 720 include one or more physical memory devices such as, for example, a local memory and one or more file storage subsystems 710. Local memory refers to random access memory (RAM) 718, read only memory (ROM) 719, or other memory device(s) generally used during actual execution of the program code. Storage subsystems 710 may be implemented as a hard disk drive (HDD), solid state drive (SSD), or other persistent data storage device. Computing system 700 may also include one or more cache memories (not shown) that provide temporary storage of at least some program code in order to reduce the number of times program code must be retrieved from storage device during execution.

Stored in the memory 720 are both data and several components that are executable by the processor 710. In particular, stored in the memory 720 and executable by the processor 710 may be cyber-physical passport application 122 code, DLT interface 127 code, dashboard application 128 code, analytics software 154 code, etc. Also stored in the memory 1820 may be a data store 124, 128 and other data. The data store 124, 128 can include an electronic repository or database relevant to collected data 125, 157; data objects 126, 159; and related information. In addition, an operating system may be stored in the memory 720 and executable by the processor 710.

Input/output (I/O) devices 712 such as a keyboard, a display device, a pointing device, monitoring device(s) 140, etc. may optionally be coupled to computing system 700. The I/O devices may be coupled to computing system 700 either directly or through intervening I/O controllers. A network adapter or interface 716 may also be coupled to computing system 700 to enable computing system to become coupled to other systems, computer systems, remote printers, and/or remote storage devices through intervening private or public networks. Modems, cable modems, Ethernet cards, and wireless transceivers are examples of different types of network adapter that may be used with computing system 100.

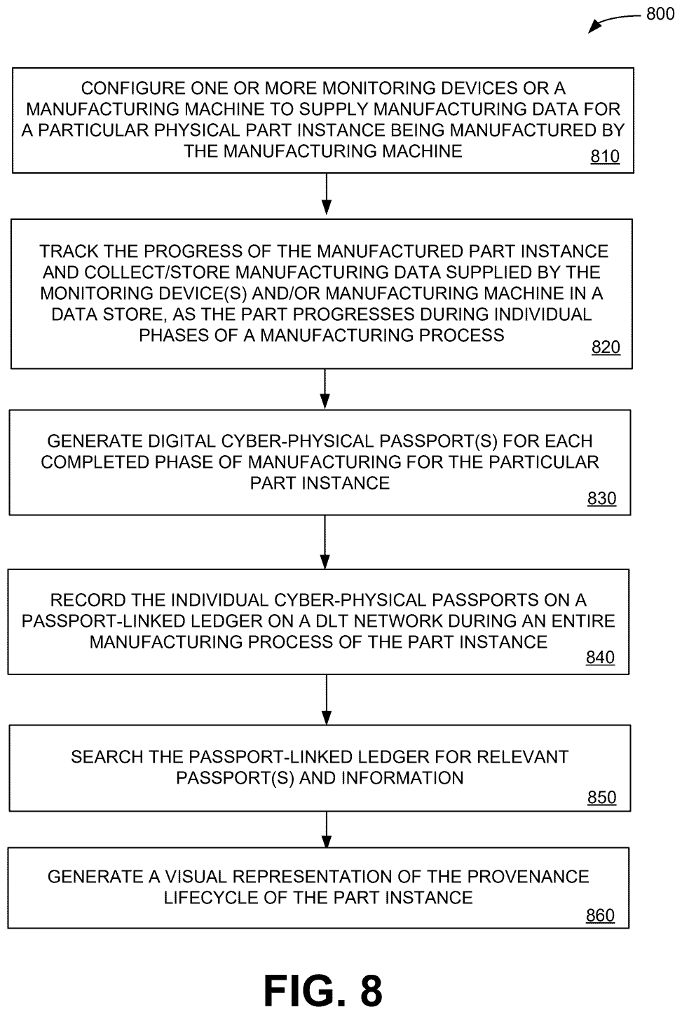

FIG. 8 is a flow chart illustrating an exemplary method 800 that may be implemented by computing system 700 (e.g., server 120) described with reference to FIG. 7. Computing system 700 may execute, or include, an architecture as described generally with reference to FIG. 7. In block 810, the computing system 700 may configure one or more monitoring devices 140 or a manufacturing machine 110 to supply manufacturing data for a particular physical part instance being manufactured by the manufacturing machine 110. In various embodiments, the monitoring device and/or manufacturing machine are located remotely from the computing device 700 and the manufacturing data comprises environmental sensor data, manufacturing sensor data, manufacturing status data, manufacturing metrics, manufacturing design files, digital outputs from various manufacturing phases/stages of operation, associated manufacturing identifiers, etc. of the one or more monitoring devices 140 and/or manufacturing machine 110. In various embodiments, if the computing system 700 performs the role of an edge server 120, the computing system 700 may supply the data it collects to another computing system, such as central server 150. Next, in block 820, the computing system 700 may track the progress of the manufactured part instance and collect and store manufacturing data supplied by the monitoring device(s) 140 and/or manufacturing machine 110 in a data store 126, as the part progresses during individual phases of a manufacturing process. In various embodiments, the manufacturing data may be stored as data objects 126. Then, in block 830, the computing system 700 may generate digital cyber-physical passport(s) for each completed phase of manufacturing for the particular part instance. In various embodiments, the cyber-physical passport 168 may provide a record of relevant unique identifiers (UUIDs) for identifying prior cyber-physical passports and linked or referenced physical part instances, data objects, and associated entities (e.g., machines, suppliers, data-hub locations, operators, etc.) that were directly involved in the manufacturing process at the completed stage, where the data objects may be stored locally by the computing system 700. In various embodiments, the cyber-physical passports may contain proof data associated with the particular physical part instance, wherein the proof data indicates a compliance status of the particular physical part instance with one or more tolerance requirements, structural requirements, functional requirements, manufacturing requirements, or compatibility requirements, as a non-limiting example. Correspondingly, in block 840, the computing system 700 records the individual cyber-physical passports 168 that it generates on a passport-linked ledger 167 on a DLT platform or network 130 during an entire manufacturing process of the part instance. Subsequently, in block 850, the computing system 700 can cause the ledger 167 to be searched for relevant passport(s) 168 and relevant information (e.g., a product item unique identifier) contained within the passports maintained on the ledger 167. With this information, in block 860, the computing system 700 can cause a visual representation of the provenance lifecycle of the particular part to be generated and shown across an entire manufacturing process of the fabricated part.

Computer program code for carrying out operations of the present disclosure may be written in a variety of computer programming languages. The program code may be executed entirely on at least one computing device (or processor), as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer.

It will be understood that each block of the flowchart illustrations and block diagrams and combinations of those blocks can be implemented by computer program instructions and/or means. These computer program instructions may be provided to a processor of a general purpose computer, special purpose computer, application specific integrated circuit (ASIC), or other programmable data processing apparatus to produce a machine, such that the instructions, which execute via the processor of the computer or other programmable data processing apparatus, create means for implementing the functions specified in the flowcharts or block diagrams.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the principles of the disclosure. All such modifications and variations are intended to be included herein within the scope of this disclosure and protected by the following claims.

What is claimed is:

1. A method comprising:
configuring, by a computing device, one or more monitoring devices or a manufacturing machine to supply manufacturing data for a particular physical part instance being manufactured by the manufacturing machine;
tracking, by the computing device, a progress of the manufactured part instance and collecting and store manufacturing data supplied by the one or more monitoring devices and/or the manufacturing machine in a data store as the particular physical part instance progresses during individual phases of a manufacturing process;
generating, by the computing device, one or more digital cyber-physical passports for each completed phase of manufacturing for the particular physical part instance, wherein the one or more digital cyber-physical passports contain proof data associated with the particular physical part instance, wherein the proof data indicates a compliance status of the particular physical part instance with one or more tolerance requirements, structural requirements, functional requirements, manufacturing requirements, or compatibility requirements; and
recording, by the computing device, individual cyber-physical passports on a cyber-physical passport-linked ledger on a distributed ledger technology platform during or after the manufacturing process of the particular physical part instance.

2. The method of claim 1, wherein the one or more digital cyber-physical passports further contain one or more links to data objects that are directly involved in the manufacturing process at the completed phase, wherein the data objects are stored locally by the computing device, wherein the data objects comprise at least a compliance requirement status reports, a compliance tolerance report, or a functional specification requirement status report.

3. The method of claim 1, wherein the proof data indicates a compliance status of the particular physical part instance with one or more tolerance requirements for the particular physical part instance, wherein the one or more tolerance requirements comprise a dimensional tolerance, a geometric tolerance, or a fit tolerance.

4. The method of claim 1, wherein the one or more digital cyber-physical passports for each completed phase of manufacturing for the particular physical part instance comprise a product passport that includes a proof formula for determining the compliance status for a particular part and a product item passport that includes the proof data that is computed using the proof formula and parameter values for the particular physical part instance, wherein the particular physical part instance is a manufactured version of the particular part.

5. The method of claim 4, wherein the proof formula comprises a mathematical formula having variables representative of parameters of the particular physical part instance.

6. The method of claim 4, wherein the proof formula comprises a logical formula having variables representative of parameters of the particular physical part instance.

7. The method of claim 1, wherein the one or more digital cyber-physical passports comprise a plurality of cyber-physical passports, wherein individual ones of the plurality of cyber-physical passports include a product passport that references a design file or a machine code design file for the particular physical part instance and a proof formula for determining the compliance status for the particular physical part instance, wherein the particular physical part instance is a composite of at least a first component part instance and a second component part instance, such that the plurality of cyber-physical passports further include a product passport for the first component part instance that references a design file or machine code design file for the first component part instance and a proof formula for determining the compliance status for the first component part instance, the plurality of cyber-physical passports further including a product passport for the second component part instance that references a design file or machine code design file for the second component part instance and a proof formula for determining the compliance status for the second component part instance, wherein the individual ones of the plurality of cyber-physical passports include a product item passport that references manufacturing data and parameters of the particular physical part instance that is composite of the first component part instance and the second component part instance, a first product item passport that references manufacturing data and parameters of the first component part instance, and a second product item passport that references manufacturing data and parameters of the second component part instance obtained during completion of the manufacturing of the particular physical part instance, wherein variables in the proof formula of the particular physical part instance represent one or more parameters of the first component part instance supplied from the first product item passport and the parameters of the second component part instance supplied from the second product item passport.

8. A system comprising:
a processor of a computing device; and
a memory in communication with the processor, the memory storing program instructions, the processor operative with the program instructions to perform the operations of:
configuring one or more monitoring devices or a manufacturing machine to supply manufacturing data for a particular physical part instance being manufactured by the manufacturing machine;
tracking a progress of the manufactured part instance and collecting and store manufacturing data supplied by the one or more monitoring devices and/or the manufacturing machine in a data store as the particular physical part instance progresses during individual phases of a manufacturing process;
generating one or more digital cyber-physical passports for each completed phase of manufacturing for the particular physical part instance, wherein the one or more digital cyber-physical passports contain proof data associated with the particular physical part instance, wherein the proof data indicates a compliance status of the particular physical part instance with one or more tolerance requirements, structural requirements, functional requirements, manufacturing requirements, or compatibility requirements; and
recording individual cyber-physical passports on a cyber-physical passport-linked ledger on a distributed ledger technology platform during the manufacturing process of the particular physical part instance.

9. The system of claim 8, wherein the one or more digital cyber-physical passports further contain one or more links to data objects that are directly involved in the manufacturing process at the completed phase, wherein the data objects are stored locally by the computing device, wherein the data objects comprise at least a compliance requirement status reports, a compliance tolerance report, or a functional specification requirement status report.

10. The system of claim 8, wherein the proof data indicates a compliance status of the particular physical part instance with one or more tolerance requirements for the particular physical part instance, wherein the one or more tolerance requirements comprise a dimensional tolerance, a geometric tolerance, or a fit tolerance.

11. The system of claim 8, wherein the one or more digital cyber-physical passports for each completed phase of manufacturing for the particular physical part instance comprise a product passport that includes a proof formula for determining the compliance status for a particular part and a product item passport that includes the proof data that is computed using the proof formula and parameter values for the particular physical part instance, wherein the particular physical part instance is a manufactured version of the particular part.

12. The system of claim 11, wherein the proof formula comprises a mathematical formula having variables representative of parameters of the particular physical part instance.

13. The system of claim 11, wherein the proof formula comprises a logical formula having variables representative of parameters of the particular physical part instance.

14. The system of claim 8, wherein the one or more digital cyber-physical passports comprise a plurality of cyber-physical passports, wherein individual ones of the plurality of cyber-physical passports include a product passport that references a design file or a machine code design file for the particular physical part instance and a proof formula for determining the compliance status for the particular physical part instance, wherein the particular physical part instance is a composite of at least a first component part instance and a second component part instance, such that the plurality of cyber-physical passports further include a product passport for the first component part instance that references a design file or machine code design file for the first component part instance and a proof formula for determining the compliance status for the first component part instance, the plurality of cyber-physical passports further including a product passport for the second component part instance that references a design file or machine code design file for the second component part instance and a proof formula for determining the compliance status for the second component part instance, wherein the individual ones of the plurality of cyber-physical passports include a product item passport that references manufacturing data and parameters of the particular physical part instance that is composite of the first component part instance and the second component part instance, a first product item passport that references manufacturing data and parameters of the first component part instance, and a second product item passport that references manufacturing data and parameters of the second component part instance obtained during completion of the manufacturing of the particular physical part instance, wherein variables in the proof formula of the particular physical part instance represent one or more parameters of the first component part instance supplied from the first product item passport and the parameters of the second component part instance supplied from the second product item passport.

15. A non-transitory computer readable medium comprising machine readable instructions that, when executed by a processor of a computing device, cause the computing device to at least:
configure one or more monitoring devices or a manufacturing machine to supply manufacturing data for a particular physical part instance being manufactured by the manufacturing machine;
track a progress of the manufactured part instance and collect and store manufacturing data supplied by the one or more monitoring devices and/or the manufacturing machine in a data store as the particular physical part instance progresses during individual phases of a manufacturing process;
generate one or more digital cyber-physical passports for each completed phase of manufacturing for the particular physical part instance, wherein the one or more digital cyber-physical passports contain proof data associated with the particular physical part instance, wherein the proof data indicates a compliance status of the particular physical part instance with one or more tolerance requirements, structural requirements, functional requirements, manufacturing requirements, or compatibility requirements; and
record individual cyber-physical passports on a cyber-physical passport-linked ledger on a distributed ledger technology platform during the manufacturing process of the particular physical part instance.

16. The non-transitory computer readable medium of claim 15, wherein the one or more digital cyber-physical passports further contain one or more links to data objects that are directly involved in the manufacturing process at the completed phase, wherein the data objects are stored locally by the computing device, wherein the data objects comprise at least a compliance requirement status reports, a compliance tolerance report, or a functional specification requirement status report.

17. The non-transitory computer readable medium of claim 15, wherein the proof data indicates a compliance status of the particular physical part instance with one or more tolerance requirements for the particular physical part instance, wherein the one or more tolerance requirements comprise a dimensional tolerance, a geometric tolerance, or a fit tolerance.

18. The non-transitory computer readable medium of claim 15, wherein the one or more digital cyber-physical passports for each completed phase of manufacturing for the particular physical part instance comprise a product passport that includes a proof formula for determining the compliance status for a particular part and a product item passport that includes the proof data that is computed using the proof formula and parameter values for the particular physical part instance, wherein the particular physical part instance is a manufactured version of the particular part.

19. The non-transitory computer readable medium of claim 18, wherein the proof formula contains variables representative of parameters of the particular physical part instance.

20. The non-transitory computer readable medium of claim 15, wherein the one or more digital cyber-physical passports comprise a plurality of cyber-physical passports, wherein individual ones of the plurality of cyber-physical passports include a product passport that references a design file or a machine code design file for the particular physical part instance and a proof formula for determining the compliance status for the particular physical part instance, wherein the particular physical part instance is a composite of at least a first component part instance and a second component part instance, such that the plurality of cyber-physical passports further include a product passport for the first component part instance that references a design file or machine code design file for the first component part instance and a proof formula for determining the compliance status for the first component part instance, the plurality of cyber-physical passports further including a product passport for the second component part instance that references a design file or machine code design file for the second component part instance and a proof formula for determining the compliance status for the second component part instance, wherein the individual ones of the plurality of cyber-physical passports include a product item passport that references manufacturing data and parameters of the particular physical part instance that is composite of the first component part instance and the second component part instance, a first product item passport that references manufacturing data and parameters of the first component part instance, and a second product item passport that references manufacturing data and parameters of the second component part instance obtained during completion of the manufacturing of the particular physical part instance, wherein variables in the proof formula of the particular physical part instance represent one or more parameters of the first component part instance supplied from the first product item passport and the parameters of the second component part instance supplied from the second product item passport.
